(19) United States
(12) Patent Application Publication
(10) Pub. No.: US 2024/0077337 A1
(43) Pub. Date: Mar. 7, 2024

(54) SCANNING ELEMENT AND INDUCTIVE POSITION MEASURING DEVICE WITH THIS SCANNING ELEMENT

(71) Applicant: DR. JOHANNES HEIDENHAIN GmbH, Traunreut (DE)

(72) Inventors: Martin STERKEL, Prien (DE); Jens-Martin GÖHRE, Surberg (DE); Tobias HUBNER, Tacherting (DE); Erich STRASSER, Trostberg (DE); Herbert EDER, Taching a. See (DE); Kai HOLLSTEIN, Traunreut (DE); Dominik ENTHOLZNER, Waldburgkirchen (DE); Karin JANUSZEWSKI, Traunstein (DE); Robert SIEGEL, Traunreut (DE)

(21) Appl. No.: 18/457,760

(22) Filed: Aug. 29, 2023

(30) Foreign Application Priority Data
Sep. 6, 2022 (EP) 22194068.7

(51) Int. Cl. G01D 5/20; G01B 7/00

(52) U.S. Cl. CPC G01D 5/2053; G01B 7/003; G01B 7/30; G01D 2205/50

(57) ABSTRACT

A sensing element for an inductive position measuring device includes an excitation track, a receiving track, a substrate made of a metallic material, and a shield layer structure. The shield layer structure includes a first layer that has a dielectric property and a second layer that is electrically conductive. The shield layer structure is arranged between the substrate and the receiving track and/or between the substrate and the excitation track.

### CROSS-REFERENCE TO RELATED APPLICATIONS

The present application claims priority to Application No. 22194068.7, filed in the European Patent Office on Sep. 6, 2022, which is expressly incorporated herein in its entirety by reference thereto.

### FIELD OF THE INVENTION

The present invention relates to a sensing element, e.g., for an inductive position measuring device for determining a relative position between a scale element and the sensing element, and to a position measuring device that includes such a sensing element.

### BACKGROUND INFORMATION

Inductive position measuring devices are used, for example, as angle measuring devices to determine the angular position of machine parts that can be rotated relative to one another. In inductive position measuring devices, excitation tracks and receiving tracks, for example, in the form of conductive paths, are often applied to a common, usually multilayer, printed circuit board, which is firmly connected, for example, to a stator of an angle measuring device. Opposite this printed circuit board is a scale element on which graduation structures are applied and which serves as the rotor of the angle measuring device. When a time-varying electrical excitation current is applied to the excitation conductive paths of the receiving track, signals dependent on the angular position are generated in receiving conductive paths of the receiving track during the relative rotation between rotor and stator. These signals are further processed in an evaluation electronic system.

Such inductive position measuring devices are often used as measuring instruments for electrical drives to determine the relative movement or the relative position of corresponding machine parts. In this instance, the generated angle position values are fed to a downstream electronic system for controlling the drives via a corresponding interface arrangement.

Furthermore, inductive position measuring devices are also frequently used for direct measurement of longitudinal displacements along an axis. The same measuring principle is used as for the angle measuring devices mentioned above, but the receiver coils and the graduation structure extend along the straight-line axis.

An inductive angle measuring device is described in European Patent Document No. 3 702 737 and U.S. Patent Application Publication No. 2020/0278220, which has a substrate made of a metal material.

### SUMMARY

Example embodiments of the present provide an inductive position measuring device that is accurate and inexpensive to produce.

According to example embodiments, a sensing element, which is, for example, adapted for an inductive position measuring device for measuring a position along a measuring direction, includes at least one excitation track and at least one receiving track. The excitation track may include one or more excitation conductive paths, and the receiving track may include, for example, a first receiving conductive path and, optionally, a second receiving conductive path. Furthermore, the sensing element includes a substrate produced from a metallic material. In addition, the sensing element includes a shield layer structure having dielectric first layer(s) and electrically conductive second layer(s). The shield layer structure is arranged—with respect to a direction perpendicular to the measuring direction—between the substrate and the receiving track. Alternatively or supplementally, the shield layer structure is arranged between the substrate and the excitation track.

The measuring direction may be a linear direction, a circumferential direction, or a tangential direction. The excitation track and the receiving track extend, for example, along the measuring direction.

According to example embodiments, the first layer has a thickness of less than 1 mm, e.g., less than 0.50 mm, less than 0.10 mm, etc.

According to example embodiments, the electrically conductive second layer of the shield layer structure is applied by a physical vapor deposition, e.g., on the dielectric first layer of the shield layer structure.

According to example embodiments, the shield layer structure also has a third layer and a fourth layer. The third layer may be arranged between the dielectric layer and the electrically conductive coat of the shield layer structure.

According to example embodiments, the sensing element includes a multilayer sensor structure that corresponds to a structure of a multilayer printed circuit board or conductive foil. The position of the sensing element should therefore be understood as a (structured) layer. The sensor structure includes at least a first electrically conductive layer and a second electrically conductive layer. The excitation track and the receiving track are produced by structuring the electrically conductive layers. Consequently, the sensor structure includes structured conductive layers in which the excitation track and the receiving track are arranged. For example, the sensor structure has exactly two electrically conductive layers in which the excitation track and the receiving track are arranged.

According to example embodiments, an insulating layer is arranged between the second electrically conductive layer and the shield layer structure. In addition, a fourth layer may be arranged between the insulating layer and the electrically conductive layer. For example, the electrically conductive second layer of the shield layer structure is arranged between the third layer and the fourth layer. The material of the third layer and/or the material of the fourth layer may include chromium. Thus, the third and fourth layers are made of a material that has a comparatively high electrical conductivity. However, the third layer and the fourth layer together have less than 50% of the thickness of the electrically conductive layer.

According to example embodiments, the dielectric first layer of the shield layer structure has a thickness of at least 2.5 μm, e.g., at least 5 μm, at least 20 μm, etc.

According to example embodiments, the sensing element includes at least one electronic component, and the shield layer structure or the electrically conductive second layer is arranged between the substrate and the electronic component. Accordingly, the shield layer structure or the electrically conductive second layer also extends below the area of the electronic component.

For example, the electronic component is adapted to evaluate signals recorded by the receiving track with regard to the position information contained therein. Thus, the signals that can be generated by the receiving track can be further processed with the aid of the electronic component, which, for example, forms an evaluation circuit. The sensing element may include several electronic components that are electrically connected to form an (evaluation) circuit. For example, the connections are arranged as conductive paths that extend in the correspondingly structured first and second layers.

According to example embodiments, the electronic component is adapted to generate or produce an excitation current that can be conducted into the excitation track. The excitation track may thus be energized with an excitation current, which has a time-varying current intensity (alternating current or mixed current). The excitation current may be generated with the aid of the electronic component, which means that it can be shaped by the electronic component. Since there is a physical relationship between the current and the voltage, the same consideration can be made for the excitation voltage.

The electronic component may be mounted on the side of the sensing element opposite the substrate, so that the sensor structure and the electronic component are arranged on the same side with respect to the substrate.

For example, the electronic circuit can be connected via a line to a ground potential (electronic ground) and the electrically conductive second layer of the shield layer structure is electrically connected to the line. The line may include a resistor and a capacitor that are connected in parallel. The shield layer structure, e.g., its conductive second layer, is, for example, planar without interruptions. The electrically conductive second layer of the shield layer structure is, for example, connected to the line by a via. For example, the line may be electrically connected to a connection element arranged as a connection for the ground potential. The second layer is electrically connected to the connection element. A connection element should be understood, for example, as an element of a connector, i.e., a connector element, or a soldered connection.

In contrast, the substrate may be mounted, for example, on an electrically conductive housing, such as a motor housing, so that the substrate is grounded through the motor housing. For example, the substrate and the electrically conductive second layer of the shield layer structure are not directly electrically connected to each other, e.g., are not grounded to each other.

The shield layer structure is used to shield interference fields so that no interference occurs in the receiving track and/or in the excitation track and, if necessary, in the electronic component. At the same time, the shield layer structure is configured such that useful signals can still be received through it with the required strength, so that accurate position determination is possible.

For example, the substrate has a thickness of more than 0.5 mm.

According to example embodiments, an inductive position measuring device includes the sensing element and a scale element, in which the sensing element is arranged opposite the scale element and is movable relative thereto.

The use of a shield layer may also be beneficial for sensing elements that operate according to an optical, capacitive, or magnetic principle, e.g., for shielding electronic components of the sensing element from interference fields.

Further features and aspects of example embodiments of the present invention are described in more detail below with reference to the appended schematic Figures.

### BRIEF DESCRIPTION OF THE DRAWINGS

FIG. 1 is a top view of a sensing element.

FIG. 2 is a top view of a scale element.

FIG. 3 is a cross-sectional view of the sensing element.

FIG. 4 is an enlarged view of the cross-sectional view of the sensing element.

### DETAILED DESCRIPTION

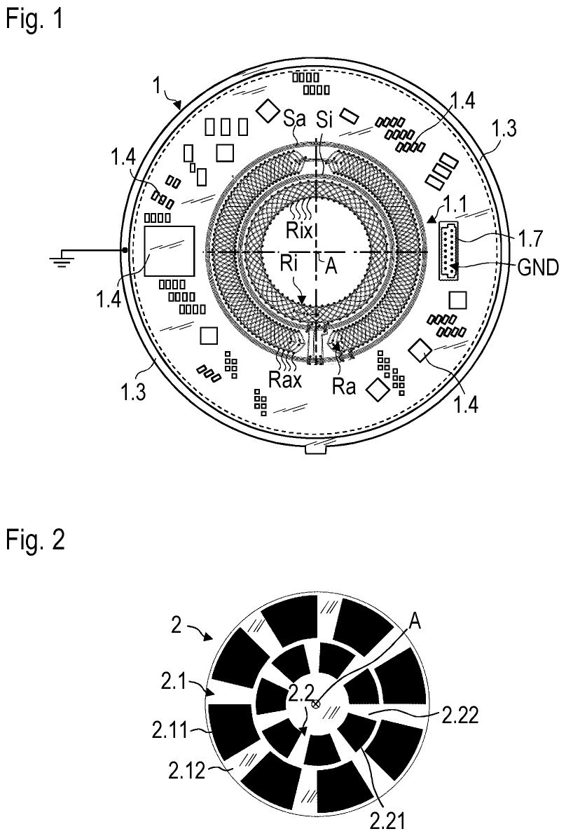

A position measuring device includes a sensing element 1, such as that illustrated in FIG. 1, and a scale element 2, such as that illustrated in FIG. 2. In the assembled state of the position measuring device, the sensing element 1 and the scale element 2 are opposite each other at an axial distance, and the scale element 2 is arranged rotatably about an axis A relative to the sensing element 1. As illustrated in FIGS. 1 and 2, the axis A is oriented orthogonally to the drawing plane. The sensing element 1 is used to sense the scale element 2. The position measuring device can thus determine the position in the circumferential direction, i.e., an angular position or rotational position of the scale element 2.

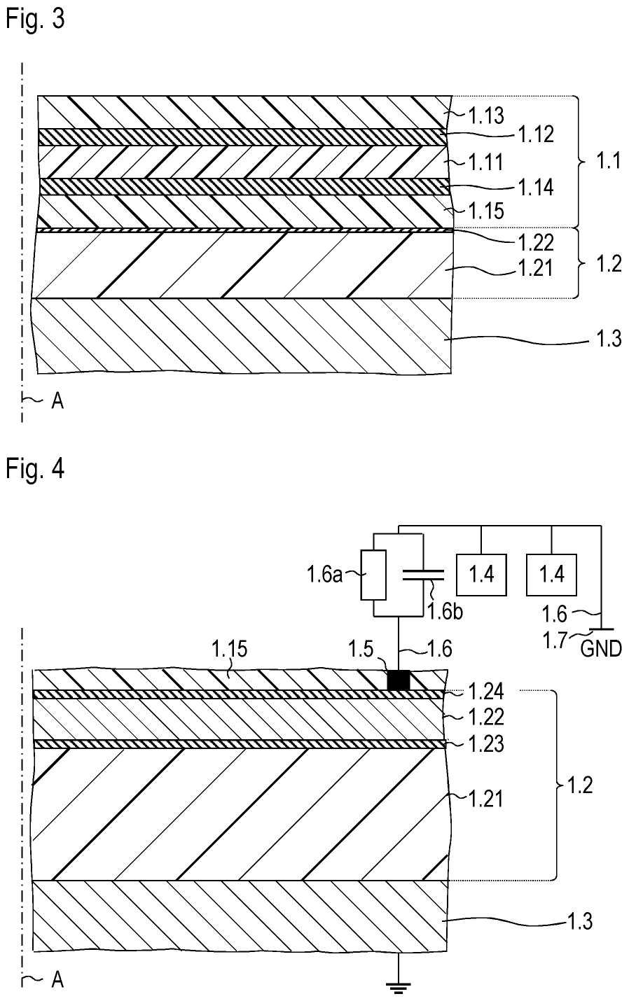

FIG. 3 is a cross-sectional view through a partial area of the sensing element 1. Accordingly, the sensing element 1 includes a sensor structure 1.1 having a first electrically conductive layer 1.12 and a second electrically conductive layer 1.14. For example, the first electrically conductive layer 1.12 and the second electrically conductive layer 1.14 are arranged as approximately 12 μm thick copper layers. A first insulating layer 1.11 is arranged between the first electrically conductive layer 1.12 and the second electrically conductive layer 1.14. Similarly, a second insulating layer 1.13 and a third insulating layer 1.15 are arranged on respective sides of the electrically conductive layer 1.12, 1.14 opposite the first insulating layer 1.11. For example, the insulating layers 1.11, 1.13, 1.15 are each made of polyimide with a thickness of approximately 20 μm. For example, the sensor structure 1.1 is very thin and has a thickness of about 100 μm. Accordingly, it may be referred to as a multilayer film, corresponding to, for example, a multilayer (flexible) printed circuit board.

The first electrically conductive layer 1.12 and the second electrically conductive layer 1.14 are configured such that excitation tracks Sa, Si and receiving tracks Ra, Ri are present, as illustrated in FIG. 1.

For example, both excitation tracks Sa, Si include several parallel excitation conductive paths. The excitation conductive paths or the excitation tracks Sa, Si enclose the receiving tracks Ra, Ri and extend along the circumferential direction around the axis A.

For example, each of the receiving tracks Ra, Ri includes four receiving conductive paths Rax, Rix (see, e.g., FIG. 1) arranged offset in the circumferential direction, so that they can provide four phase-shifted signals in accordance with the offset. The receiving conducting paths Rax, Rix of a respective receiving track Ra, Ri extend alternately in the first electrically conductive layer 1.12 and in the second electrically conductive layer 1.14 of the sensor structure 1.1, connected by vias, so that undesirable short circuits are avoided at crossing points. The receiving conductive paths Rax, Rix have a spatially periodic path that is substantially sine-shaped or sinusoidal. The receiving conducting paths Rix of the inner receiving track Ri have a different period length than the receiving conducting paths Rax of the outer receiving track Ra. The receiving conductive paths Rax, Rix are offset and electrically connected such that they provide 0° and 900 signals, on the one hand, and 45° and 135° signals, on the other hand. A first position signal may be determined from the 0° and 900 signals, and a second position signal redundant with respect to the first position signal may be determined from the 45° and 135° signals.

In addition, the sensing element 1 has an electronic circuit with a plurality of electronic components 1.4, illustrated schematically in FIG. 1. For example, the electronic circuit includes an ASIC component.

The signals received by the receiving conducting paths Rax, Rix are routed to the electronic circuit, e.g., to an area that serves as the evaluation circuit.

In addition, the sensing element 1 has a connection element 1.7, e.g., arranged as a pin of a connector. The connection element 1.7 or the pin is intended for connection to the ground potential GND during operation of the sensing element 1. The connector is also intended for coupling a multi-core output cable and is used, for example, to supply the sensing element with electrical energy and to transmit signals to a subsequent electronic system.

The sensing element 1 has a comparatively thick substrate 1.3 for mechanical reinforcement, including a metallic material. For example, the substrate 1.3 may be produced from a soft magnetic material. The substrate 1.3 may be made of steel and may have a thickness of 1.5 mm.

As illustrated in FIG. 3, a shield layer structure 1.2 is arranged between the substrate 1.3 and the sensor structure 1.1 and includes a dielectric, i.e., electrically insulating, first layer 1.21 and an electrically conductive second layer 1.22. The dielectric first layer 1.21 is deposited on the substrate 1.3 and, for example, is a polyimide layer with a thickness of 30 μm. As illustrated in FIG. 4, the shield layer structure 1.2 further includes a third layer 1.23 and a fourth layer 1.24. During production of the sensing element 1, the substrate 1.3 is coated with the dielectric first layer 1.21. Then, the third layer 1.23 is applied to the first layer 1.21, in which the third layer 1.23 is made of chromium and has a thickness of only 30 nm. A second coat of copper with a thickness of 200 nm is applied to the third layer 1.23 of chromium, to form the electrically conductive second layer 1.22. The fourth layer 1.24 is applied to the second layer 1.22, in which fourth layer includes chromium and has a thickness of 30 nm. For example, the electrically conductive second layer 1.22 and the third and fourth layers 1.23, 1.24 are deposited by a physical vapor deposition (PVD) method. For example, a sputtering or cathode sputtering method may be used in this regard. The insulating layer 1.15 is applied to the shield layer structure 1.2, followed by the other components of the sensor structure 1.1. Finally, the electronic components are assembled 1.4.

The shield layer structure 1.2 is connected to an electrical line 1.6 by a via 1.5. As illustrated in FIG. 4, an ohmic resistor 1.6a and a capacitor 1.6b are connected in parallel. The electronic circuit, which includes the electronic components 1.4, is connected to the ground potential GND via the line 1.6. For example, the position measuring device may be connected to a downstream electronic system via the connector 1.7 (see, e.g., FIG. 1) mounted on the sensing element 1. For this purpose, an output cable may be coupled to the connector 1.7, having at least one core that is electrically connected to a ground, e.g., a ground of the downstream electronic system arranged outside the sensing element 1.

The electrically conductive second layer 1.22 is electrically connected via the line 1.6 to the connector 1.7 or to a pin of the connector 1.7, which has the ground potential GND, e.g., the ground potential GND is 0 V. The capacitor 1.6b can dissipate high-frequency interference signals, and the parallel connection of the ohmic resistor 1.6a provides that charges can be dissipated. Thus, interference energy is dissipated via the line 1.6 (e.g., also via the connector 1.7 and the connecting cable).

The third layer 1.23 and the fourth layer 1.24 are arranged as adhesion promoters or as oxygen barriers. For example, the fourth layer 1.24 prevents oxygen from penetrating through the insulating layer 1.15 to the electrically conductive layer 1.22. Oxygen would react with the material of the electrically conductive layer 1.22, e.g., copper. Moreover, this reaction would lead to a minimization of the adhesion properties between the second layer 1.22 and the third layer 1.23, and especially between the second layer 1.22 and the fourth layer 1.24. The shielding properties would be impaired, e.g., by the aforementioned effects.

The electrically conductive second layer 1.22 is structured by an etching process such that the edge of the second layer 1.22 is set back with respect to the edge of the substrate 1.3 (see, e.g., FIG. 1). The electrically conductive second layer 1.22 extends over the entire surface between the substrate 1.3 and the excitation tracks Sa, Si, the receiving tracks Ri, Ra, and the electronic components 1.4 of the electronic circuit. Although the third layer 1.23 and the fourth layer 1.24 are made of electrically conductive chromium, for example, the shielding effect is mostly achieved by the second layer 1.22 made of copper. This is partly due to the higher electrical conductivity of copper compared to chromium, but mainly due to the much greater thickness (e.g., 200 nm) of the second layer 1.22 compared to the thickness of the third layer 1.23 and the fourth layer 1.24 (e.g., 30 nm each).

The sensing element 1 is configured such that the electrically conductive second layer 1.22 is arranged electrically isolated from the substrate 1.3, i.e., the second layer 1.22 is not electrically connected to the substrate 1.3.

As illustrated in FIG. 2, the scale element 2 has a disc-shaped form, when viewed from the top. The scale element 2 includes of a carrier, e.g., produced from epoxy resin, and on which two graduation tracks 2.1, 2.2 are arranged. The graduation tracks 2.1, 2.2 are annular and are arranged concentrically with respect to the axis A with different diameters on the carrier. The graduation tracks 2.1, 2.2 include graduation structures, each including a periodic sequence of alternately arranged electrically conductive graduation areas 2.11, 2.21 and non-conductive graduation areas 2.12, 2.22. For example, copper is applied to the carrier as the material for the electrically conductive graduation areas 2.11, 2.21. In the non-conductive graduation areas 2.12, 2.22, on the other hand, no layer is applied to the carrier. With the arrangement with two graduation tracks 2.1, 2.2, the angular position of the scale element 2 can be determined absolutely. The outermost graduation track 2.1 of the scale element 2 has the greater number of graduation areas 2.11, 2.12 along a circumferential line, so that a higher resolution with respect to the measurement of the angular position can be achieved.

In the assembled state, the sensing element 1 and the scale element 2 are opposite one another with an axial distance (relative to the axis A) or with an axial air gap, so that when there is a relative rotation between the scale element 2 and the sensing element 1, a signal depending on the respective angular position can be generated in each of the conductive paths of the receiving tracks Ra, Ri by induction effects. A prerequisite for the formation of corresponding signals is that the excitation tracks Sa, Si generate a time-varying electromagnetic excitation field in the area of the respective sensed graduation structures. For example, the excitation tracks Sa, Si are arranged as a plurality of planar-parallel current-carrying individual conductive paths. The electronic circuit of the sensing element 1 operates not only as an evaluation element, but also as an excitation control element under whose control the excitation current is generated or produced, which flows through the excitation tracks Sa, Si. Thus, the excitation tracks Sa, Si are supplied with current by one and the same excitation control element.

If the excitation tracks Sa, Si are supplied with current, a tubular or cylindrical electromagnetic field is formed around them. The field lines of the resulting electromagnetic field extend around the excitation tracks Sa, Si, and the direction of the field lines depends on the direction of the current in the excitation tracks Sa, Si. Eddy currents are induced in the area of the conductive partial areas 2.11, 2.21, so that a modulation of the field is achieved which is dependent on the angular position. Accordingly, through the receiving tracks Ra, Ri, the relative angular position can be measured. The receiving conductive paths are arranged within their receiving track Ra, Ri such that they each provide signals phase-shifted by 90°, so that the direction of rotation can also be determined. The signals generated by the receiving tracks Ra, Ri are further processed by an evaluation circuit.

Although the substrate 1.3 includes a metallic material that is electrically connected to the ground potential during operation of the position measuring device (see, e.g., FIG. 1), for example, by contact with a grounded metal housing, a significant improvement of the measurement signals is achieved by the additional shield layer structure 1.2. The shield layer structure 1.2 achieves a good shielding effect against interference fields, and the shield layer structure 1.2 does not significantly attenuate the useful signals of the inductive position measuring device. Position signals of high quality can be generated by the sensing element 1. The shield layer structure 1.2, e.g., the electrically conductive second layer 1.22, is electrically connected to the ground potential GND of the circuit of the sensing element 1 and is, for example, not electrically connected to the substrate 1.3, which is grounded during operation, but is electrically isolated and spaced from it by the first layer 1.21.

What is claimed is:

1. A sensing element for an inductive position measuring device, comprising:
an excitation track;
a receiving track;
a substrate made of a metallic material; and
a shield layer structure arranged between the substrate and the receiving track and/or between the substrate and the excitation track and including:
a dielectric first layer; and
an electrically conductive second layer.

2. The sensing element according to claim 1, wherein the first layer has a thickness of less than 1 mm.

3. The sensing element according to claim 1, wherein the second layer is arranged as a physical vapor deposited layer.

4. The sensing element according to claim 1, wherein the shield layer structure includes a third layer arranged between the first layer and the second layer.

5. The sensing element according to claim 1, further comprising a multilayer sensor structure including a first electrically conductive layer and a second electrically conductive layer, wherein the excitation track and the receiving track are structured in the first electrically conductive layer of the multilayer sensor structure and in the second electrically conductive layer of the multilayer sensor structure.

6. The sensing element according to claim 5, wherein an insulating layer is arranged between the second electrically conductive layer of the multilayer sensor structure and the shield layer structure, a fourth layer being arranged between the insulating layer and the second layer of the shield layer structure.

7. The sensing element according to claim 1, wherein the shield layer structure includes a third layer and a fourth layer, the second layer of the shield layer structure being arranged between the third layer and the fourth layer.

8. The sensing element according to claim 1, wherein the screen layer structure includes a third layer and/or a fourth layer, the second layer of the screen layer structure being adjacent to the third layer and/or the fourth layer, the third layer and/or the fourth layer including chromium.

9. The sensing element according to claim 1, wherein a thickness of the first layer of the layer structure is at least 2.5 μm.

10. The sensing element according to claim 1, further comprising at least one electronic component, the shield layer structure being arranged between the substrate and the electronic component.

11. The sensing element according to claim 10, wherein the electronic component is adapted to evaluate signals received by the receiving track.

12. The sensing element according to claim 10, wherein the electronic component is adapted to generate an excitation current that is conductible to the excitation track.

13. The sensing element according to claim 1, further comprising at least one electronic component associated with an electronic circuit that is electrically connected to a connection element arranged as a connection to a ground potential, the second layer being electrically connected to the connection element.

14. The sensing element according to claim 13, wherein the second layer is electrically connected to the connection element via a line, an ohmic resistor and a capacitor being connected in parallel in the line.

15. The sensing element according to claim 1, wherein the receiving track and the excitation track extend along a measurement direction of the inductive position measuring device.

16. The sensing device according to claim 15, wherein the measurement direction is a linear direction, a circumferential direction, or a tangential direction.

17. An inductive position measuring device, comprising:
a scale element; and
a sensing element arranged opposite the scale element, the scale element and the sensing element being movable relative to each other, the sensing element including:
an excitation track;
a receiving track;
a substrate made of a metallic material; and
a shield layer structure arranged between the substrate and the receiving track and/or between the substrate and the excitation track and including:
a dielectric first layer; and
an electrically conductive second layer.

18. The inductive position measuring device according to claim 17, wherein the scale element and the sensing element are movable relative to each other along a measurement direction of the inductive position measuring device.

19. The inductive position measuring device according to claim 17, wherein the measurement direction is a linear direction, a circumferential direction, or a tangential direction.

20. The inductive position measuring device according to claim 17, wherein the sensing element is adapted to determine a position of the scale element.
